(19) United States
(12) Patent Application Publication
(10) Pub. No.: US 2021/0360920 A1
(43) Pub. Date: Nov. 25, 2021

(54) HERBICIDAL COMBINATIONS

(71) Applicant: UPL LTD, Haldia (IN)

(72) Inventors: Carlos Eduardo Fabri, Indianopolis (BR); Vicente Amadeu Gongora, Indianopolis (BR); Diego Guimaraes Arruda, Indianopolis (BR); Beth E. Sears, King of Prussia, PA (US); Prakash Mahadev Jadhav, King of Prussia, PA (US); Jaidev Rajnikant Shroff, Dubai (AE); Vikram Rajnikant Shroff, Dubai (AE)

(21) Appl. No.: 16/980,578

(22) PCT Filed: Mar. 6, 2019
(86) PCT No.: PCT/IB2019/051794

§ 371 Date: Sep. 14, 2020

(30) Foreign Application Priority Data
Mar. 26, 2018 (IN) 201831011137

(51) Int. Cl. A01N 43/653; A01N 43/707; A01N 43/50; A01N 43/80; A01P 13/00

(52) U.S. Cl. CPC A01N 43/653; A01N 43/707; A01P 13/00; A01N 43/80; A01N 43/50

(57) ABSTRACT

The present invention discloses herbicidal combinations for controlling undesirable plants. The present invention more specifically relates to a synergistic combination of herbicides, compositions and method for controlling weeds.

### FIELD OF THE INVENTION

The present invention relates to herbicidal combinations for controlling undesirable plants. The present invention more specifically relates to a synergistic combination of herbicides for controlling weeds.

### BACKGROUND OF THE INVENTION

Weed control is an essential part of crop protection. Agriculturalists usually control or suppress weed growth by using herbicides at various stages before and after plant growth depending on the weed type and the level of infestation.

The increasing level of resistance has led to the use of combinations of herbicides that have different modes of action, which allows for broader spectrum of control and allow for resistance management. Combinations used currently do not effectively handle resistant and persistent weeds. There is therefore a continuous need in the art for improved combinations with enhanced efficacy and broader spectrum of weed control that delay the onset of resistance.

PPO inhibitor herbicides are mostly used to control broadleaf plants and have some activity on grasses. They have a limited translocation in plants and are used to control weeds in field crops, vegetables, tree fruits and vines, small fruits, nurseries, lawns, etc. PPO inhibitors usually burn plant tissues within hours or days of exposure, making them an excellent tool to control unwanted weeds both pre and post emergent.

Sulfentrazone is PPO inhibitor herbicide that is used for pre-emergent use to control a wide range of broadleaf, grasses and sedges in soybean as well as other crops. Combination of carfentrazone ethyl with other herbicides are known from U.S. Pat. No. 8,822,380 B2 (Walter et. al) or WO2015026923A2 (Degenhardt et. al,). Walter et al teach a combination comprising sulfentrazone in combination with quinclorac in a specific synergistic ratio. Degenhardt et. al teaches a combination comprising sulfentrazone, propyzamide and ethalfluralin.

Metribuzin is a triazinone herbicide and its activity is due to interference with photosystem II electron transport in plant chloroplasts. A selective contact herbicide, metribuzin is used for control of both pre and post emergent weeds in cereals as well as other crops. Combinations of metribuzin are known in the art. For example, U.S. Pat. No. 5,990,048 A (Dahmen et. al) teaches combinations of metribuzin and sulfosulfuron.

There remains a need for improved herbicidal combinations that can effectively control weeds thereby improving yield and plant health, with reduced phytotoxicity. Weeds might not be controlled with double combinations of herbicides, let alone a single broad-spectrum herbicide such as glyphosate. There is also a need for herbicidal combination that gives good residual control, while at the same time ensuring complete control of weeds as well as control a larger spectrum of burndown weeds.

Sulfentrazone is a PPO inhibitor herbicide. Its chemical name is N-[2,4-dichloro-5-[4-(difluoromethyl)-4,5-dihydro-3-methyl-5-oxo-1H-1,2,4-triazol-1-yl]phenyl]-methane sulfonamide and has the chemical structure:

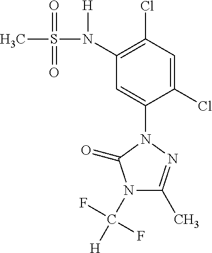 [SMILES: Cc1nn(-c2cc(NS(C)(=O)=O)c(Cl)cc2Cl)c(=O)n1C(F)F]

Metribuzin is a photosystem II inhibitor herbicide. Its chemical name is 4-amino-6-(1,1-dimethylethyl)-3-(methylthio)-1,2,4-triazin-5(4H)-one and has the chemical structure:

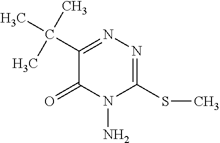

Sulfentrazone and Metribuzin together are usually effective in the control of pre-emergent weeds as well as burndown weeds. However, there is not much in the way of residual control and control of resistant weeds. There is therefore, a need in the art, for an herbicidal combination which offers a broader spectrum of weed control, which can attain near complete control of weeds at lower use rates, and which gives good residual control.

Embodiments of the present invention may therefore ameliorate one or more of the above-mentioned problems:

### OBJECTS OF THE INVENTION

Therefore, one object of the present invention is to provide a synergistic herbicidal combination.

Another object of the present invention is to provide a method of controlling weeds at a locus by application of a synergistic herbicidal combination.

Another object of the present invention is to provide a composition comprising a synergistic herbicidal combination.

Yet another object of the present invention is to provide a method of increasing yield in a crop by application of a synergistic herbicidal combination.

Another object of the present invention is to provide a method of improving the plant health by application of a synergistic herbicidal combination.

Another object of the present invention is to provide a synergistic herbicidal combination which offers a broader and more complete spectrum of weed control.

Another object of the present invention is to provide a synergistic herbicidal combination which provides a better control of weeds at lower use rates, and which gives good residual control.

Another object of the present invention is to provide a synergistic herbicidal combination which is synergistic and thus helps in resistance management.

Some or all these and other objects of the invention can be achieved by way of the invention described hereinafter.

### SUMMARY OF THE INVENTION

In one aspect the present invention relates to a herbicidal combination comprising:
(a) at least one triazolone herbicide;
(b) a photosystem II inhibitor herbicide; and
(c) an ALS inhibitor herbicide

In another aspect the present invention relates to a herbicidal combination comprising:
(a) at least one triazolone herbicide selected from the group consisting of amicarbazone, bencarbazone, carfentazone, flucarbazone, ipfencarbazone, propoxycarbazone, sulfentrazone and thiencarbazone;
(b) a photosystem II inhibitor herbicide selected from ametridione, amibuzin, ethiozin, hexazinone, isomethiozin, metamitron, metribuzin, trifludimoxazin and their salts and esters; and
(c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect, the present invention provides a herbicidal combination comprising (a) sulfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In yet another aspect the present inventio provides a method of controlling weeds at a locus, the method comprising applying, to the locus, a combination comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect the present invention provides a method of controlling weeds at a locus, the method comprising applying, to the locus, a combination comprising a) sulfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect the present invention provides a composition comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect the present invention provides a composition comprising:
a) sulfentrazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect the present invention provides a method of controlling weeds at a locus, said method comprising applying a composition comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) an photosystem II inhibitor herbicide selected from ametridione, amibuzin, ethiozin, hexazinone, isomethiozin, Metamitron, metribuzin, trifludimoxazin and their salts and esters;
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and
d) at least one agrochemically acceptable excipient.

In another aspect the present invention provides a method of controlling weeds at a locus, said method comprising applying a composition comprising a) sulfentrazone; (b) an photosystem II inhibitor herbicide selected from ametridione, amibuzin, ethiozin, hexazinone, isomethiozin, Metamitron, metribuzin, trifludimoxazin and their salts and esters; (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and (d) at least one agrochemically acceptable excipient.

In another aspect the present invention provides a method of controlling weeds at a locus, said method comprising applying a composition comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) an photosystem II inhibitor herbicide selected from ametridione, amibuzin, ethiozin, hexazinone, isomethiozin, Metamitron, metribuzin, trifludimoxazin and their salts and esters;
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and
d) at least one agrochemically acceptable excipient.

In another aspect the present invention provides a method of controlling weeds at a locus, said method comprising applying a composition comprising a) sulfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and (d) at least one agrochemically acceptable excipient.

### DETAILED DESCRIPTION OF THE INVENTION

The inventors have surprisingly found that at least one triazolone herbicide, when added to the combination of photosystem II inhibitor herbicides and either an ALS inhibitor herbicide selected from imidazolinone herbicides or a bleacher herbicide resulted in an unexpected synergy.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, or retardation. The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

Thus, an aspect of the present invention relates to a herbicidal combination comprising (a) at least one triazolone herbicide, at least one photosystem II inhibitor herbicide and either an ALS inhibitor herbicide selected from imidazolinone herbicides or a bleacher herbicide.

Thus, in an aspect, the present invention provides a herbicidal combination comprising:
(a) at least one triazolone herbicide selected from the group consisting of amicarbazone, bencarbazone, carfentazone, flucarbazone, ipfencarbazone, propoxycarbazone, sulfentrazone and thiencarbazone;
(b) a photosystem II inhibitor herbicide selected from ametridione, amibuzin, ethiozin, hexazinone, isomethiozin, Metamitron, metribuzin, trifludimoxazin and their salts and esters; and
(c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is sulfentrazone.

Thus, in an embodiment, the present invention provides a herbicidal combination comprising (a) sulfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is carfentrazone.

Thus, in an embodiment, the present invention provides a herbicidal combination comprising (a) carfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an aspect, the present provides a method of controlling weeds at a locus by applying, to the locus, a combination of the present invention.

Thus, in an aspect, the present invention provides a method of controlling weeds at a locus, the method comprising applying, to the locus, a combination comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is sulfentrazone.

Thus, in this embodiment, the present invention provides a method of controlling weeds at a locus, the method comprising applying, to the locus, a combination comprising a) sulfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is carfentrazone.

Thus, in this embodiment, the present invention provides a method of controlling weeds at a locus, the method comprising applying, to the locus, a combination comprising a) carfentrazone; (b) an photosystem II inhibitor herbicide selected from ametridione, amibuzin, ethiozin, hexazinone, isomethiozin, Metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In another aspect, the present invention provides a composition comprising the combinations of the present invention.

Thus, in this aspect, the present invention provides a composition comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is sulfentrazone.

Thus, in this embodiment, the present invention provides a composition comprising:
a) sulfentrazone;
b) a photosystem II inhibitor herbicide selected from ametridione, amibuzin, ethiozin, hexazinone, isomethiozin, Metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the preferred triazolone herbicide is carfentrazone.

Thus, in this embodiment, the present invention provides a composition comprising:
a) carfentrazone;
b) a photosystem II inhibitor herbicide selected from ametridione, amibuzin, ethiozin, hexazinone, isomethiozin, metamitron, metribuzin, trifludimoxazin and their salts and esters; and
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

In an embodiment, the compositions of the present invention comprise at least one agrochemically acceptable excipient.

Thus, in this embodiment, the present invention provides a composition comprising (a) sulfentrazone; (b) an photosystem II inhibitor herbicide selected from ametridione, amibuzin, ethiozin, hexazinone, isomethiozin, metamitron, metribuzin, trifludimoxazin and their salts and esters; and (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; (d) at least one agrochemically acceptable excipient.

In an aspect, the present provides a method of controlling weeds at a locus by applying, to the locus, a composition of the present invention.

Thus, in this aspect, the present invention provides a method of controlling weeds at a locus, said method comprising applying a composition comprising:
a) at least one triazolone herbicide selected from the group consisting of amicarbazone, bencarbazone, carfentazone, flucarbazone, ipfencarbazone, propoxycarbazone, sulfentrazone and thiencarbazone;
b) an photosystem II inhibitor herbicide selected from ametridione, amibuzin, ethiozin, hexazinone, isomethiozin, metamitron, metribuzin, trifludimoxazin and their salts and esters;
c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and
d) at least one agrochemically acceptable excipient.

In an embodiment, the preferred triazolone herbicide is sulfentrazone.

Thus, in this embodiment, the present invention provides a method of controlling weeds at a locus, said method comprising applying a composition comprising a) sulfentrazone; (b) an photosystem II inhibitor herbicide selected from ametridione, amibuzin, ethiozin, hexazinone, isomethiozin, Metamitron, metribuzin, trifludimoxazin and their salts and esters; (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and (d) at least one agrochemically acceptable excipient.

In an embodiment, the preferred triazolone herbicide is carfentrazone.

Thus, in this embodiment, the present invention provides a method of controlling weeds at a locus, said method comprising applying a composition comprising a) carfentrazone; (b) an photosystem II inhibitor herbicide selected from ametridione, amibuzin, ethiozin, hexazinone, isomethiozin, Metamitron, metribuzin, trifludimoxazin and their salts and esters; (c) an ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione; and (d) at least one agrochemically acceptable excipient.

Each of the aspect described above may have one or more embodiments.

In each of these embodiments, apart from the triazolone herbicide, the embodiments may include the preferred photosystem II herbicide and a preferred imidazolinone herbicide or a preferred bleacher herbicide according to the present invention.

Each of the embodiments described hereinafter may apply to one or all the aspects described hereinabove. These embodiments are intended to be read as being preferred features of one or all the aspects described hereinabove. Each of the embodiments described hereinafter applies to each of the aspects described hereinabove individually.

In an embodiment, the present invention provides preferred combinations, compositions and methods thereof. The methods of the invention include a method of controlling weeds at a locus by applying to the locus the combination or the composition, or a method of increasing yield in a crop by application of the combination or composition, or a method of improving the plant health by application at the locus of the plant the combination or the composition. The embodiments described herein describe the preferred embodiments of all these possible combinations, compositions and methods of the invention.

Thus, an embodiment of the present invention may include the preferred selection of:
a) the triazolone herbicide is selected from the group consisting of carfentazone, flucarbazone, and sulfentrazone; and
b) the photosystem II inhibitor herbicide selected from hexazinone, metamitron, and metribuzin; and
c) the ALS inhibitor herbicide selected from imazamox, imazapic, imazapyr, and imazethapyr; or
d) the bleacher herbicide selected from clomazone, diflufenican, mesotrione, and tembotrione.

Alternatively, an embodiment of the present invention may include the preferred selection as tabulated below, which are to be construed as exemplary embodiments according to any aspect, described hereinabove, of the present invention. These embodiments are exemplary embodiments only and do not limit the present invention.

TABLE 1

| | | Preferred | Preferred | |
|---|---|---|---|---|
| | Preferred | photosystem | ALS | Preferred |
| Embodiment | triazolone | II inhibitor | inhibitor | bleacher |
| No. | herbicide | herbicide | herbicide | herbicide |
| 1 | Carfentrazone | Hexazinone | Imazamox | — |
| 2 | Carfentrazone | Hexazinone | Imazapic | — |
| 3 | Carfentrazone | Hexazinone | Imazapyr | — |
| 4 | Carfentrazone | Hexazinone | Imazethapyr | — |
| 5 | Carfentrazone | Hexazinone | — | Clomazone |
| 6 | Carfentrazone | Hexazinone | — | Diflufenican |
| 7 | Carfentrazone | Hexazinone | — | Mesotrione |
| 8 | Carfentrazone | Hexazinone | — | Tembotrione |
| 9 | Carfentrazone | Metamitron | Imazamox | — |
| 10 | Carfentrazone | Metamitron | Imazapic | — |
| 11 | Carfentrazone | Metamitron | Imazapyr | — |
| 12 | Carfentrazone | Metamitron | Imazethapyr | — |
| 13 | Carfentrazone | Metamitron | — | Clomazone |
| 14 | Carfentrazone | Metamitron | — | Diflufenican |
| 15 | Carfentrazone | Metamitron | — | Mesotrione |
| 16 | Carfentrazone | Metamitron | — | Tembotrione |
| 17 | Carfentrazone | Metribuzin | Imazamox | — |
| 18 | Carfentrazone | Metribuzin | Imazapic | — |
| 19 | Carfentrazone | Metribuzin | Imazapyr | — |
| 20 | Carfentrazone | Metribuzin | Imazethapyr | — |
| 21 | Carfentrazone | Metribuzin | — | Clomazone |
| 22 | Carfentrazone | Metribuzin | — | Diflufenican |
| 23 | Carfentrazone | Metribuzin | — | Mesotrione |
| 24 | Carfentrazone | Metribuzin | — | Tembotrione |
| 25 | Flucarbazone | Hexazinone | Imazamox | — |
| 26 | Flucarbazone | Hexazinone | Imazapic | — |
| 27 | Flucarbazone | Hexazinone | Imazapyr | — |
| 28 | Flucarbazone | Hexazinone | Imazethapyr | — |
| 29 | Flucarbazone | Hexazinone | — | Clomazone |
| 30 | Flucarbazone | Hexazinone | — | Diflufenican |
| 31 | Flucarbazone | Hexazinone | — | Mesotrione |
| 32 | Flucarbazone | Hexazinone | — | Tembotrione |
| 33 | Flucarbazone | Metamitron | Imazamox | — |
| 34 | Flucarbazone | Metamitron | Imazapic | — |
| 35 | Flucarbazone | Metamitron | Imazapyr | — |
| 36 | Flucarbazone | Metamitron | Imazethapyr | — |
| 37 | Flucarbazone | Metamitron | — | Clomazone |
| 38 | Flucarbazone | Metamitron | — | Diflufenican |
| 39 | Flucarbazone | Metamitron | — | Mesotrione |
| 40 | Flucarbazone | Metamitron | — | Tembotrione |
| 41 | Flucarbazone | Metribuzin | Imazamox | — |
| 42 | Flucarbazone | Metribuzin | Imazapic | — |
| 43 | Flucarbazone | Metribuzin | Imazapyr | — |
| 44 | Flucarbazone | Metribuzin | Imazethapyr | — |
| 45 | Flucarbazone | Metribuzin | — | Clomazone |
| 46 | Flucarbazone | Metribuzin | — | Diflufenican |
| 47 | Flucarbazone | Metribuzin | — | Mesotrione |
| 48 | Flucarbazone | Metribuzin | — | Tembotrione |
| 49 | Sulfentrazone | Hexazinone | Imazamox | — |
| 50 | Sulfentrazone | Hexazinone | Imazapic | — |
| 51 | Sulfentrazone | Hexazinone | Imazapyr | — |
| 52 | Sulfentrazone | Hexazinone | Imazethapyr | — |
| 53 | Sulfentrazone | Hexazinone | — | Clomazone |
| 54 | Sulfentrazone | Hexazinone | — | Diflufenican |
| 55 | Sulfentrazone | Hexazinone | — | Mesotrione |
| 56 | Sulfentrazone | Hexazinone | — | Tembotrione |
| 57 | Sulfentrazone | Metamitron | Imazamox | — |
| 58 | Sulfentrazone | Metamitron | Imazapic | — |
| 59 | Sulfentrazone | Metamitron | Imazapyr | — |
| 60 | Sulfentrazone | Metamitron | Imazethapyr | — |
| 61 | Sulfentrazone | Metamitron | — | Clomazone |
| 62 | Sulfentrazone | Metamitron | — | Diflufenican |
| 63 | Sulfentrazone | Metamitron | — | Mesotrione |
| 64 | Sulfentrazone | Metamitron | — | Tembotrione |
| 65 | Sulfentrazone | Metribuzin | Imazamox | — |
| 66 | Sulfentrazone | Metribuzin | Imazapic | — |
| 67 | Sulfentrazone | Metribuzin | Imazapyr | — |
| 68 | Sulfentrazone | Metribuzin | Imazethapyr | — |
| 69 | Sulfentrazone | Metribuzin | — | Clomazone |
| 70 | Sulfentrazone | Metribuzin | — | Diflufenican |
| 71 | Sulfentrazone | Metribuzin | — | Mesotrione |
| 72 | Sulfentrazone | Metribuzin | — | Tembotrione |

An embodiment of the present invention may be a herbicidal combination comprising a) sulfentrazone; (b) metribuzin; and (c) at least one ALS inhibitor herbicide selected from imidazolinone herbicide selected from imazamethabenz, imazamox, imazapic, imazapyr, imazaquin, imazethapyr and their salts and esters or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

A preferred embodiment of the present invention may be a herbicidal combination comprising a) sulfentrazone; (b) metribuzin; and (c) at least one ALS inhibitor herbicide selected from imidazolinone herbicide selected from imazamethabenz, imazamox, imazapic, imazapyr, imazaquin, imazethapyr and their salts and esters.

A preferred embodiment of the present invention may be a herbicidal combination comprising a) sulfentrazone; (b) metribuzin; and (c) imazamox and its salts and esters.

Another embodiment of the present invention may be a herbicidal combination comprising a) sulfentrazone; (b) metribuzin; and (c) at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

A preferred embodiment of the present invention may be a herbicidal combination comprising a) sulfentrazone; (b) metribuzin; and (c) diflufenican.

Another preferred embodiment of the present invention may be a herbicidal combination comprising a) sulfentrazone; (b) metribuzin; and (c) clomazone.

Another embodiment of the present invention may be a herbicidal combination comprising a) sulfentrazone; (b) metribuzin; and (c) at least one bleacher herbicide selected from mesotrione, sulcotrione, tembotrione and tefuryltrione.

Another embodiment of the present invention may be a herbicidal combination comprising a) sulfentrazone; (b) metribuzin; and (c) at least one bleacher herbicide selected from picolinafen or aclonifen.

Another embodiment of the present invention may be a herbicidal combination comprising a) sulfentrazone; (b) metamitron; and (c) at least one ALS inhibitor herbicide selected from imidazolinone herbicide selected from imazamethabenz, imazamox, imazapic, imazapyr, imazaquin, imazethapyr and their salts and esters or at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

Another embodiment of the present invention may be a herbicidal combination comprising a) sulfentrazone; (b) metamitron; and (c) at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

Another embodiment of the present invention may be a herbicidal combination comprising a) sulfentrazone; (b) hexazinone; and (c) at least one ALS inhibitor herbicide selected from imidazolinone herbicide selected from imazamethabenz, imazamox, imazapic, imazapyr, imazaquin, imazethapyr and their salts and esters or at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

Another embodiment of the present invention may be a herbicidal combination comprising a) sulfentrazone; (b) hexazinone; and (c) at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

A preferred embodiment of the present invention may be a herbicidal combination comprising a) sulfentrazone; (b) hexazinone; and (c) isoxaflutole.

Another embodiment of the present invention may be a herbicidal combination comprising a) sulfentrazone; (b) trifludimoxazin; and (c) at least one ALS inhibitor herbicide selected from imidazolinone herbicide selected from imazamethabenz, imazamox, imazapic, imazapyr, imazaquin, imazethapyr and their salts and esters or at least one bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

Alternatively, an embodiment of the present invention may include the preferred selection as tabulated below in table 2, which are to be construed as exemplary embodiments according to any aspect, described hereinabove, of the present invention. These embodiments are exemplary embodiments only and do not limit the present invention.

TABLE 2

| | | | |
|---|---|---|---|
| 73 | Sulfentrazone | Metribuzin | Imazamethabenz |
| 74 | Sulfentrazone | Metribuzin | Imazamox |
| 75 | Sulfentrazone | Metribuzin | Imazapic |
| 76 | Sulfentrazone | Metribuzin | Imazapyr |
| 77 | Sulfentrazone | Metribuzin | Imazaquin |
| 78 | Sulfentrazone | Metribuzin | Imazethapyr |
| 79 | Sulfentrazone | Metribuzin | Aclonifen |
| 80 | Sulfentrazone | Metribuzin | Clomazone |
| 81 | Sulfentrazone | Metribuzin | Diflufenican |
| 82 | Sulfentrazone | Metribuzin | Isoxaflutole |
| 83 | Sulfentrazone | Metribuzin | Mesotrione |
| 84 | Sulfentrazone | Metribuzin | Picolinafen |
| 85 | Sulfentrazone | Metribuzin | Sulcotrione |
| 86 | Sulfentrazone | Metribuzin | Tembotrione |
| 87 | Sulfentrazone | Metribuzin | Topramezone |
| 88 | Sulfentrazone | Metribuzin | Bicyclopyrone |
| 89 | Sulfentrazone | Metribuzin | Amitrole |
| 90 | Sulfentrazone | Metribuzin | Beflubutamid |
| 91 | Sulfentrazone | Metribuzin | Benzobicyclon |
| 92 | Sulfentrazone | Metribuzin | Benzofenap |
| 93 | Sulfentrazone | Metribuzin | Fluridone |
| 94 | Sulfentrazone | Metribuzin | Flurochloridone |
| 95 | Sulfentrazone | Metribuzin | Flurtamone |
| 96 | Sulfentrazone | Metribuzin | Isoxachlortole |
| 97 | Sulfentrazone | Metribuzin | Norflurazon |
| 98 | Sulfentrazone | Metribuzin | Pyrasulfotole |
| 99 | Sulfentrazone | Metribuzin | Pyrazolynate |
| 100 | Sulfentrazone | Metribuzin | Pyrazoxyfen |
| 101 | Sulfentrazone | Metribuzin | Tefuryltrione |
| 102 | Sulfentrazone | Ametridione | Imazamethabenz |
| 103 | Sulfentrazone | Ametridione | Imazamox |
| 104 | Sulfentrazone | Ametridione | Imazapic |
| 105 | Sulfentrazone | Ametridione | Imazapyr |
| 106 | Sulfentrazone | Ametridione | Imazaquin |
| 107 | Sulfentrazone | Ametridione | Imazethapyr |
| 108 | Sulfentrazone | Ametridione | Aclonifen |
| 109 | Sulfentrazone | Ametridione | Clomazone |
| 110 | Sulfentrazone | Ametridione | Diflufenican |
| 111 | Sulfentrazone | Ametridione | Isoxaflutole |
| 112 | Sulfentrazone | Ametridione | Mesotrione |
| 113 | Sulfentrazone | Ametridione | Picolinafen |
| 114 | Sulfentrazone | Ametridione | Sulcotrione |
| 115 | Sulfentrazone | Ametridione | Tembotrione |
| 116 | Sulfentrazone | Ametridione | Topramezone |
| 117 | Sulfentrazone | Ametridione | Bicyclopyrone |
| 118 | Sulfentrazone | Ametridione | Amitrole |
| 119 | Sulfentrazone | Ametridione | Beflubutamid |
| 120 | Sulfentrazone | Ametridione | Benzobicyclon |
| 121 | Sulfentrazone | Ametridione | Benzofenap |
| 122 | Sulfentrazone | Ametridione | Fluridone |
| 123 | Sulfentrazone | Ametridione | Flurochloridone |
| 124 | Sulfentrazone | Ametridione | Flurtamone |
| 125 | Sulfentrazone | Ametridione | Isoxachlortole |
| 126 | Sulfentrazone | Ametridione | Norflurazon |
| 127 | Sulfentrazone | Ametridione | Pyrasulfotole |
| 128 | Sulfentrazone | Ametridione | Pyrazolynate |
| 129 | Sulfentrazone | Ametridione | Pyrazoxyfen |
| 130 | Sulfentrazone | Ametridione | Tefuryltrione |
| 131 | Sulfentrazone | Amibuzin | Imazamethabenz |
| 132 | Sulfentrazone | Amibuzin | Imazamox |
| 133 | Sulfentrazone | Amibuzin | Imazapic |
| 134 | Sulfentrazone | Amibuzin | Imazapyr |
| 135 | Sulfentrazone | Amibuzin | Imazaquin |
| 136 | Sulfentrazone | Amibuzin | Imazethapyr |
| 137 | Sulfentrazone | Amibuzin | Aclonifen |
| 138 | Sulfentrazone | Amibuzin | Clomazone |
| 139 | Sulfentrazone | Amibuzin | Diflufenican |
| 140 | Sulfentrazone | Amibuzin | Isoxaflutole |
| 141 | Sulfentrazone | Amibuzin | Mesotrione |
| 142 | Sulfentrazone | Amibuzin | Picolinafen |
| 143 | Sulfentrazone | Amibuzin | Sulcotrione |
| 144 | Sulfentrazone | Amibuzin | Tembotrione |
| 145 | Sulfentrazone | Amibuzin | Topramezone |
| 146 | Sulfentrazone | Amibuzin | Bicyclopyrone |
| 147 | Sulfentrazone | Amibuzin | Amitrole |
| 148 | Sulfentrazone | Amibuzin | Beflubutamid |
| 149 | Sulfentrazone | Amibuzin | Benzobicyclon |
| 150 | Sulfentrazone | Amibuzin | Benzofenap |
| 151 | Sulfentrazone | Amibuzin | Fluridone |
| 152 | Sulfentrazone | Amibuzin | Flurochloridone |
| 153 | Sulfentrazone | Amibuzin | Flurtamone |
| 154 | Sulfentrazone | Amibuzin | Isoxachlortole |
| 155 | Sulfentrazone | Amibuzin | Norflurazon |
| 156 | Sulfentrazone | Amibuzin | Pyrasulfotole |
| 157 | Sulfentrazone | Amibuzin | Pyrazolynate |
| 158 | Sulfentrazone | Amibuzin | Pyrazoxyfen |
| 159 | Sulfentrazone | Amibuzin | Tefuryltrione |
| 160 | Sulfentrazone | Ethiozin | Imazamethabenz |
| 161 | Sulfentrazone | Ethiozin | Imazamox |
| 162 | Sulfentrazone | Ethiozin | Imazapic |
| 163 | Sulfentrazone | Ethiozin | Imazapyr |
| 164 | Sulfentrazone | Ethiozin | Imazaquin |
| 165 | Sulfentrazone | Ethiozin | Imazethapyr |
| 166 | Sulfentrazone | Ethiozin | Aclonifen |
| 167 | Sulfentrazone | Ethiozin | Clomazone |
| 168 | Sulfentrazone | Ethiozin | Diflufenican |
| 169 | Sulfentrazone | Ethiozin | Isoxaflutole |
| 170 | Sulfentrazone | Ethiozin | Mesotrione |
| 171 | Sulfentrazone | Ethiozin | Picolinafen |
| 172 | Sulfentrazone | Ethiozin | Sulcotrione |
| 173 | Sulfentrazone | Ethiozin | Tembotrione |
| 174 | Sulfentrazone | Ethiozin | Topramezone |
| 175 | Sulfentrazone | Ethiozin | Bicyclopyrone |
| 176 | Sulfentrazone | Ethiozin | Amitrole |
| 177 | Sulfentrazone | Ethiozin | Beflubutamid |
| 178 | Sulfentrazone | Ethiozin | Benzobicyclon |
| 179 | Sulfentrazone | Ethiozin | Benzofenap |
| 180 | Sulfentrazone | Ethiozin | Fluridone |
| 181 | Sulfentrazone | Ethiozin | Flurochloridone |
| 182 | Sulfentrazone | Ethiozin | Flurtamone |
| 183 | Sulfentrazone | Ethiozin | Isoxachlortole |
| 184 | Sulfentrazone | Ethiozin | Norflurazon |
| 185 | Sulfentrazone | Ethiozin | Pyrasulfotole |
| 186 | Sulfentrazone | Ethiozin | Pyrazolynate |
| 187 | Sulfentrazone | Ethiozin | Pyrazoxyfen |
| 188 | Sulfentrazone | Ethiozin | Tefuryltrione |
| 189 | Sulfentrazone | Hexazinone | Imazamethabenz |
| 190 | Sulfentrazone | Hexazinone | Imazamox |
| 191 | Sulfentrazone | Hexazinone | Imazapic |
| 192 | Sulfentrazone | Hexazinone | Imazapyr |
| 193 | Sulfentrazone | Hexazinone | Imazaquin |
| 194 | Sulfentrazone | Hexazinone | Imazethapyr |
| 195 | Sulfentrazone | Hexazinone | Aclonifen |
| 196 | Sulfentrazone | Hexazinone | Clomazone |
| 197 | Sulfentrazone | Hexazinone | Diflufenican |
| 198 | Sulfentrazone | Hexazinone | Isoxaflutole |
| 199 | Sulfentrazone | Hexazinone | Mesotrione |
| 200 | Sulfentrazone | Hexazinone | Picolinafen |
| 201 | Sulfentrazone | Hexazinone | Sulcotrione |
| 202 | Sulfentrazone | Hexazinone | Tembotrione |
| 203 | Sulfentrazone | Hexazinone | Topramezone |
| 204 | Sulfentrazone | Hexazinone | Bicyclopyrone |
| 205 | Sulfentrazone | Hexazinone | Amitrole |
| 206 | Sulfentrazone | Hexazinone | Beflubutamid |
| 207 | Sulfentrazone | Hexazinone | Benzobicyclon |
| 208 | Sulfentrazone | Hexazinone | Benzofenap |
| 209 | Sulfentrazone | Hexazinone | Fluridone |
| 210 | Sulfentrazone | Hexazinone | Flurochloridone |
| 211 | Sulfentrazone | Hexazinone | Flurtamone |
| 212 | Sulfentrazone | Hexazinone | Isoxachlortole |
| 213 | Sulfentrazone | Hexazinone | Norflurazon |
| 214 | Sulfentrazone | Hexazinone | Pyrasulfotole |
| 215 | Sulfentrazone | Hexazinone | Pyrazolynate |
| 216 | Sulfentrazone | Hexazinone | Pyrazoxyfen |
| 217 | Sulfentrazone | Hexazinone | Tefuryltrione |
| 218 | Sulfentrazone | Isomethiozin | Imazamethabenz |
| 219 | Sulfentrazone | Isomethiozin | Imazamox |
| 220 | Sulfentrazone | Isomethiozin | Imazapic |
| 221 | Sulfentrazone | Isomethiozin | Imazapyr |
| 222 | Sulfentrazone | Isomethiozin | Imazaquin |
| 223 | Sulfentrazone | Isomethiozin | Imazethapyr |
| 224 | Sulfentrazone | Isomethiozin | Aclonifen |
| 225 | Sulfentrazone | Isomethiozin | Clomazone |
| 226 | Sulfentrazone | Isomethiozin | Diflufenican |
| 227 | Sulfentrazone | Isomethiozin | Isoxaflutole |
| 228 | Sulfentrazone | Isomethiozin | Mesotrione |
| 229 | Sulfentrazone | Isomethiozin | Picolinafen |
| 230 | Sulfentrazone | Isomethiozin | Sulcotrione |
| 231 | Sulfentrazone | Isomethiozin | Tembotrione |
| 232 | Sulfentrazone | Isomethiozin | Topramezone |
| 233 | Sulfentrazone | Isomethiozin | Bicyclopyrone |
| 234 | Sulfentrazone | Isomethiozin | Amitrole |
| 235 | Sulfentrazone | Isomethiozin | Beflubutamid |
| 236 | Sulfentrazone | Isomethiozin | Benzobicyclon |
| 237 | Sulfentrazone | Isomethiozin | Benzofenap |
| 238 | Sulfentrazone | Isomethiozin | Fluridone |
| 239 | Sulfentrazone | Isomethiozin | Flurochloridone |
| 240 | Sulfentrazone | Isomethiozin | Flurtamone |
| 241 | Sulfentrazone | Isomethiozin | Isoxachlortole |
| 242 | Sulfentrazone | Isomethiozin | Norflurazon |
| 243 | Sulfentrazone | Isomethiozin | Pyrasulfotole |
| 244 | Sulfentrazone | Isomethiozin | Pyrazolynate |
| 245 | Sulfentrazone | Isomethiozin | Pyrazoxyfen |
| 246 | Sulfentrazone | Isomethiozin | Tefuryltrione |
| 247 | Sulfentrazone | Metamitron | Imazamethabenz |
| 248 | Sulfentrazone | Metamitron | Imazamox |
| 249 | Sulfentrazone | Metamitron | Imazapic |
| 250 | Sulfentrazone | Metamitron | Imazapyr |
| 251 | Sulfentrazone | Metamitron | Imazaquin |
| 252 | Sulfentrazone | Metamitron | Imazethapyr |
| 253 | Sulfentrazone | Metamitron | Aclonifen |
| 254 | Sulfentrazone | Metamitron | Clomazone |
| 255 | Sulfentrazone | Metamitron | Diflufenican |
| 256 | Sulfentrazone | Metamitron | Isoxaflutole |
| 257 | Sulfentrazone | Metamitron | Mesotrione |
| 258 | Sulfentrazone | Metamitron | Picolinafen |
| 259 | Sulfentrazone | Metamitron | Sulcotrione |
| 260 | Sulfentrazone | Metamitron | Tembotrione |
| 261 | Sulfentrazone | Metamitron | Topramezone |
| 262 | Sulfentrazone | Metamitron | Bicyclopyrone |
| 263 | Sulfentrazone | Metamitron | Amitrole |
| 264 | Sulfentrazone | Metamitron | Beflubutamid |
| 265 | Sulfentrazone | Metamitron | Benzobicyclon |
| 266 | Sulfentrazone | Metamitron | Benzofenap |
| 267 | Sulfentrazone | Metamitron | Fluridone |
| 268 | Sulfentrazone | Metamitron | Flurochloridone |
| 269 | Sulfentrazone | Metamitron | Flurtamone |
| 270 | Sulfentrazone | Metamitron | Isoxachlortole |
| 271 | Sulfentrazone | Metamitron | Norflurazon |
| 272 | Sulfentrazone | Metamitron | Pyrasulfotole |
| 273 | Sulfentrazone | Metamitron | Pyrazolynate |
| 274 | Sulfentrazone | Metamitron | Pyrazoxyfen |
| 275 | Sulfentrazone | Metamitron | Tefuryltrione |
| 276 | Sulfentrazone | Trifludimoxazin | Imazamethabenz |
| 277 | Sulfentrazone | Trifludimoxazin | Imazamox |
| 278 | Sulfentrazone | Trifludimoxazin | Imazapic |
| 279 | Sulfentrazone | Trifludimoxazin | Imazapyr |
| 280 | Sulfentrazone | Trifludimoxazin | Imazaquin |
| 281 | Sulfentrazone | Trifludimoxazin | Imazethapyr |
| 282 | Sulfentrazone | Trifludimoxazin | Aclonifen |
| 283 | Sulfentrazone | Trifludimoxazin | Clomazone |
| 284 | Sulfentrazone | Trifludimoxazin | Diflufenican |
| 285 | Sulfentrazone | Trifludimoxazin | Isoxaflutole |
| 286 | Sulfentrazone | Trifludimoxazin | Mesotrione |
| 287 | Sulfentrazone | Trifludimoxazin | Picolinafen |
| 288 | Sulfentrazone | Trifludimoxazin | Sulcotrione |
| 289 | Sulfentrazone | Trifludimoxazin | Tembotrione |
| 290 | Sulfentrazone | Trifludimoxazin | Topramezone |
| 291 | Sulfentrazone | Trifludimoxazin | Bicyclopyrone |
| 292 | Sulfentrazone | Trifludimoxazin | Amitrole |
| 293 | Sulfentrazone | Trifludimoxazin | Beflubutamid |
| 294 | Sulfentrazone | Trifludimoxazin | Benzobicyclon |
| 295 | Sulfentrazone | Trifludimoxazin | Benzofenap |
| 296 | Sulfentrazone | Trifludimoxazin | Fluridone |
| 297 | Sulfentrazone | Trifludimoxazin | Flurochloridone |
| 298 | Sulfentrazone | Trifludimoxazin | Flurtamone |
| 299 | Sulfentrazone | Trifludimoxazin | Isoxachlortole |
| 300 | Sulfentrazone | Trifludimoxazin | Norflurazon |
| 301 | Sulfentrazone | Trifludimoxazin | Pyrasulfotole |
| 302 | Sulfentrazone | Trifludimoxazin | Pyrazolynate |
| 303 | Sulfentrazone | Trifludimoxazin | Pyrazoxyfen |
| 304 | Sulfentrazone | Trifludimoxazin | Tefuryltrione |

The combinations may be applied to the locus of the weeds in an herbicidally effective amount. The selection of the appropriate effective amounts depends on the density of weed infestation, weather patterns, crop health and many other factors, which may be made conveniently by a person skilled in the art. The effective amounts of these herbicides in the synergistic combination of the present invention is not particularly limiting.

In an embodiment, the combination of the present invention may be combined with at least one other active ingredient selected from the group consisting of herbicides, insecticides, fungicides, biological agents, plant growth activators, fertilizers or combinations thereof.

Thus, in an embodiment, the combination of the present invention may be combined with yet another herbicide. Exemplary herbicides that may be combined with the combination of the present invention may be selected from, but not limited to, herbicides belonging to classes such as ACCase inhibitors, ALS inhibitors, EPSP synthase inhibitors, synthetic auxins, auxin transport inhibitors, HPPD inhibitors, lipid synthesis inhibitors, long chain fatty acid inhibitors, as well as herbicides with unknown modes of action.

In an embodiment, the total amount of triazolone herbicide in the composition may typically be in the range of 0.1 to 99% by weight, preferably 0.2 to 90% by weight. The total amount of the photosystem II inhibitor herbicide in the composition may be in the range of 0.1 to 99% by weight. The total amount of the ALS inhibitor selected from imidazolinone herbicide or bleacher herbicide in the composition may be in the range of 0.1 to 10% by weight.

In an embodiment, the constituent herbicides of the combination of the present invention may be admixed in ratio of (1-80):(1-80):(1-10) of sulfentrazone, the photosystem II inhibitor herbicide and the ALS inhibitor herbicide selected from imidazolinone herbicides or the bleacher herbicide respectively.

In an aspect, the present invention may provide herbicidal combinations comprising sulfentrazone, at least one photosystem II inhibitor herbicide, at least one ALS inhibitor herbicide selected from an imidazolinone herbicide or at least one bleacher herbicide and their salts and esters thereof and a herbicidal safener.

In an embodiment, the safener may be selected from benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, Jiecaoxi, mefenpyr, mephenate, metcamifen, naphthalic anhydride, oxabetrinil and their salts and esters.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

Thus, in another aspect, the present invention provides a method of controlling weeds at a locus, the method comprising applying a combination comprising sulfentrazone, at least one photosystem II inhibitor herbicide and either at least one ALS inhibitor herbicide selected from imidazolinone herbicides or at least one bleacher herbicide to the locus.

Thus, embodiments of the present invention may provide a method of controlling weeds at a locus, said method comprising application of synergistic combination of sulfentrazone, at least one photosystem II inhibitor herbicide and either at least one ALS inhibitor herbicide selected from imidazolinone herbicides or at least one bleacher herbicide and optionally a fourth active ingredient.

In an embodiment, the fourth active ingredient may be selected from herbicide, insecticide, fungicide, biological agent, plant growth activator, fertilizers and combinations thereof.

The target weeds may be selected from

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa; Portulacaceae weeds: Portulaca oleracea; Caryophyllaceae weeds: Stellaria media, Cerastium holosteoides, Cerastium glomeratum, Spergula arvensis, Silene gallica

Molluginaceae weeds: Mollugo verticillata; Chenopodiaceae weeds: Chenopodium album, Chenopodium ambrosioides, Kochia scoparia, Salsola kali, Atriplex spp.; Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella; Papaveraceae weeds: Papaver rhoeas, Argemone Mexicana; Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus; Dinebra weeds: Dinebra Americana, Dinebra aquatic, Dinebra aristidoides, Dinebra bromoides, Dinebra calycina, Dinebra caudata, Dinebra chinensis, Dinebra chloride, Dinebra chondrosioides, Dinebra coerulescens, Dinebra cristata, Dinebra curtipendula, Dinebra decipiens, Dinebra divaricate, Dinebra divaricatissima, Dinebra dura, Dinebra guineensis, Dinebra hirsute, Dinebra hirta, Dinebra juncifolia, Dinebra ligulata, Dinebra lima, Dinebra melicoides, Dinebra nealleyi, Dinebra neesii, Dinebra panicea, Dinebra panicoides, Dinebra pubescens, Dinebra repens, Dinebra scabra, Dinebra secunda, Dinebra simoniana, Dinebra southwoodii, Dinebra squarrosa, Dinebra srilankensis, Dinebra tuaensis, Dinebra verticillate, Dinebra retroflexa, Dinebra haareri, Dinebra marquisensis, Dinebra perrieri, Dinebra polycarpha, Dinebra somalensis Capparaceae weeds: Cleome affinis; Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis; Oxalidaceae weeds: Oxalis corniculata, Oxalis strica, Oxalis oxyptera; Geraniaceae weeds: Geranium carolinense, Erodium cicutarium; Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis; Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica; Violaceae weeds: Viola arvensis, Viola tricolor; Cucurbitaceae weeds: Sicyos angulatus, Echinocystis lobata, Momordica charantia; Lythraceae weeds: Lythrum salicaria; Apiaceae weeds: Hydrocotyle sibthorpioides; Sapindaceae weeds: Cardiospermum halicacabum; Primulaceae weeds: Anagallis arvensis; Asclepiadaceae weeds: Asclepias syriaca, Ampelamus albidus; Rubiaceae weeds: Galium aparine, Galium spurium var. echinospermon, Spermacoce latifolia, Richardia brasiliensis, Borreria alata; Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia; Boraginaceae weeds: Myosotis arvensis; Lamiaceae weeds: Lamium purpureum, Lamium amplexicaule, Leonotis nepetaefolia, Hyptis suaveolens, Hyptis lophanta, Leonurus sibiricus, Stachys arvensis; Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides; Scrophulariaceae weeds: Veronica hederaefolia, Veronica persica, Veronica arvensis; Plantaginaceae weeds: Plantago asiatica; Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis; Liliaceae weeds: Allium canadense, Allium vineale; Commelinaceae weeds: Commelina communis, Commelina bengharensis, Commelina erecta; Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis; Cyperaceae weeds: Cyperus microiria, Cyperus iria, Cyperus odoratus, Cyperus rotundus, Cyperus esculentus, Kyllinga gracillima, Equisetaceae weeds: Equisetum arvense, Equisetum palustre, Trianthema weeds and the like.

In an embodiment, the individual components of the combination of the present invention may be applied to the locus either simultaneously or sequentially, such that sulfentrazone, a photosystem II inhibitor herbicide and either a ALS inhibitor herbicide selected from imidazolinone herbicides or a bleacher herbicide may be applied in a tank mix or as a pre-mixed composition.

In an embodiment, combination of the present invention may be applied either pre- or post-emergent. In a preferred embodiment, the combination of the present invention may be used pre-emergent, and pre-plant. The advantage of the combination is surprisingly good residual effects, and quick burndown of the weeds when applied pre-plant or pre-emergent, and of course, a synergistic complementation between the herbicides of the combination.

The method of control of the present invention may be carried out by spraying the suggested tank mixes, or the individual herbicides may be formulated as a kit-of-parts containing various components that may be mixed as instructed prior to spraying.

In an embodiment the present invention provides a kit-of-parts comprising:
a) a first container comprising sulfentrazone;
b) a second container comprising a photosystem II inhibitor herbicide and a ALS inhibitor herbicide selected from imidazolinone herbicides or a bleacher herbicide
c) an instruction manual instructing an user to admix the contents of two containers.

In an embodiment, the components of the present invention may be packaged such that sulfentrazone, a photosystem II inhibitor herbicide and either a ALS inhibitor herbicide selected from imidazolinone herbicides or a bleacher herbicide may be packaged separately and then tank mixed before the spraying.

In another embodiment, the components of the present invention may be packaged such that sulfentrazone, a photosystem II inhibitor herbicide and either a ALS inhibitor herbicide selected from imidazolinone herbicides or a bleacher herbicide may be packaged separately, whereas other additives are packaged separately, such that the two maybe tank mixed at the time of spraying.

In another embodiment, the components of the present invention may be packaged as composition such that the photosystem II inhibitor herbicide and the either a ALS inhibitor herbicide selected from imidazolinone herbicides or a bleacher herbicide are formulated into one composition and other additives and sulfentrazone is packaged separately, such that the two maybe tank mixed at the time of spraying.

Therefore, in another aspect, the present invention provides a composition comprising sulfentrazone, at least one photosystem II inhibitor herbicide and either at least one ALS inhibitor herbicide selected from imidazolinone herbicides or at least one bleacher herbicide, and at least one agrochemically acceptable excipient.

In an embodiment, the composition of the present invention may contain agriculturally acceptable excipient/adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

Thus, in another aspect, the present invention provides a method of controlling weeds at a locus, said method comprising applying a composition comprising sulfentrazone, at least one photosystem II inhibitor herbicide and either at least one ALS inhibitor herbicide selected from imidazolinone herbicides or at least one bleacher herbicide and at least one agrochemically acceptable excipient.

In an aspect, the present invention provides a method of improving yield of the crop grown at a locus, said method comprising applying a composition comprising sulfentrazone, at least one photosystem II inhibitor herbicide and either at least one ALS inhibitor herbicide selected from imidazolinone herbicides or at least one bleacher herbicide and at least one agrochemically acceptable excipient.

In an aspect, the present invention provides, methods of improving plant health, said method comprising applying a composition comprising sulfentrazone, at least one photosystem II inhibitor herbicide and either at least one ALS inhibitor herbicide selected from imidazolinone herbicides or at least one bleacher herbicide and at least one agrochemically acceptable excipient at the locus of the plant.

Surprisingly, it has been found by the present inventors that sulfentrazone, a photosystem II inhibitor herbicide and either a ALS inhibitor herbicide selected from imidazolinone herbicides or a bleacher herbicide when applied individually, was ineffective in the control of weeds, but demonstrated excellent synergistic control on weeds when applied together. The combination controlled the weed both pre and post emergently. The combination of sulfentrazone, a photosystem II inhibitor herbicide and either a ALS inhibitor herbicide selected from imidazolinone herbicides or a bleacher herbicide was found to efficiently control broadleaf weeds, sedges, and grasses a locus. The current invention therefore provides advantageous methods of controlling weeds both pre and post emergently. The present method also provides a broader spectrum of controlling weeds that helps in resistance management, thus preventing the weed from becoming resistant to either of the herbicides whist providing a broader spectrum of control at lower use rates.

### Example 1

| | | | % control of Greenfox tail in Soybean | | | | | |
|---|---|---|---|---|---|---|---|---|
| | | | Dosage | | | | | |
| | | | 14 DAA | | 28 DAA | | 45 DAA | |
| Active | Rate Unit | | Expected | Actual | Expected | Actual | Expected | Actual |
| Untreated | — | | — | 0 | — | 0 | — | 0 |
| Clomazone | 32 | Fl oz/A | — | 85 | — | 56.7 | — | 32.9 |
| Metribuzin | 12 | Fl oz/A | — | 63.4 | — | 39.9 | — | 22.7 |
| Sulfentrazone | 7.7 | Fl oz/A | — | 68.5 | — | 46.6 | — | 29.7 |

| | | | | | | | |
|---|---|---|---|---|---|---|---|
| Clomazone + | 32 + 7.7 + 12 Fl oz/A | 67.43 | 99 | 83.42 | 98.7 | 65.57 | 98.1 |
| Metribuzin + | | | | | | | |
| Sulfentrazone | | | | | | | |

| | | | |
|---|---|---|---|
| Observed - | 31.57 | 15.28 | 32.53 |
| Expected | | | |
| efficacy | | | |

Conclusion: From the above table it is evident that the triple combination is not only effective and synergistic in controlling the Greenfox tail weed but also persistence in providing the control for longer duration of time.

### Example 2

| | | | % control of Palmer amaranth in Soybean | | | | | |
|---|---|---|---|---|---|---|---|---|
| | | | Dosage | | | | | |
| | | | 14 DAA | | 28 DAA | | 45 DAA | |
| Active | Rate Unit | | Expected | Actual | Expected | Actual | Expected | Actual |
| Untreated | — | | — | 0 | — | 0 | — | 0 |
| Clomazone | 32 | Fl oz/A | — | 60 | — | 43.3 | — | 16.4 |
| Metribuzin | 12 | Fl oz/A | — | 65 | — | 50 | — | 36.1 |
| Sulfentrazone | 7.7 | Fl oz/A | — | 80 | — | 62 | — | 39.4 |

| | | | | | | | |
|---|---|---|---|---|---|---|---|
| Clomazone + | 32 + 7.7 + 12 Fl oz/A | 86.28 | 98.7 | 93 | 98.5 | 77 | 98.1 |
| Metribuzin + | | | | | | | |
| Sulfentrazone | | | | | | | |

| | | | |
|---|---|---|---|
| Observed - | 12.42 | 5.5 | 21.1 |
| Expected | | | |
| efficacy | | | |

Conclusion: From the above table it is evident that the triple combination is not only effective and synergistic incontrolling the Palmer amaranth weed but also persistence in providing the control for longer duration of time.

### Example 3

| | | | % control of Tall morning glory in Soybean | | | | | |
|---|---|---|---|---|---|---|---|---|
| | | | Dosage | | | | | |
| | | | 14 DAA | | 28 DAA | | 45 DAA | |
| Active | Rate Unit | | Expected | Actual | Expected | Actual | Expected | Actual |
| Untreated | — | | — | 0 | — | 0 | — | 0 |
| Clomazone | 32 | Fl oz/A | — | 53.3 | — | 30 | — | 13 |
| Metribuzin | 12 | Fl oz/A | — | 53.3 | — | 39.6 | — | 16.4 |
| Sulfentrazone | 7.7 | Fl oz/A | — | 66.7 | — | 42.8 | — | 22.5 |

| | | | | | | | |
|---|---|---|---|---|---|---|---|
| Clomazone + | 32 + 7.7 + 12 Fl oz/A | 90 | 92.7 | 82.42 | 91 | 46.32 | 89.4 |
| Metribuzin + | | | | | | | |
| Sulfentrazone | | | | | | | |

| | | | |
|---|---|---|---|
| Observed - | 2.7 | 8.58 | 43.08 |
| Expected | | | |
| efficacy | | | |

Conclusion: From the above table it is evident that the triple combination is not only effective and synergistic incontrolling the Tall morning glory weed but also persistence in providing the control for longer duration of time.

1. A herbicidal combination comprising:
(a) at least one triazolone herbicide selected amicarbazone, bencarbazone, carfentazone, flucarbazone, ipfencarbazone, propoxycarbazone, sulfentrazone, and thiencarbazone;
(b) a photosystem II inhibitor herbicide selected from ametridione, amibuzin, ethiozin, hexazinone, isomethiozin, metamitron, metribuzin, trifludimoxazin, their salts and esters; and
(c) an ALS inhibitor herbicide selected from an imidazolinone herbicide selected from imazamethabenz, imazamox, imazapic, imazapyr, imazaquin, imazethapyr, their salts and esters; or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen and tefuryltrione.

2. The combination as claimed in claim 1, wherein the triazolone herbicide (a) comprises sulfentrazone.

3. The combination as claimed in claim 1, wherein the triazolone herbicide (a) comprises sulfentrazone, the photosystem II inhibitor herbicide (b) comprises metribuzin; and the ALS inhibitor herbicide (c) comprises the imidazoline herbicide.

4. The combination as claimed in claim 1, wherein the triazolone herbicide comprises (a) sulfentrazone, the photosystem II inhibitor herbicide (b) comprises metribuzin; and the ALS inhibitor herbicide (c) comprises the at least one bleacher herbicide.

5. The herbicidal combination of claim 1 comprising
i. a) sulfentrazone; (b) metribuzin; and (c) diflufenican;
ii. a) sulfentrazone; (b) metribuzin; and (c) imazamox;
iii. a) sulfentrazone; (b) metribuzin; and (c) clomazone;
iv. a) sulfentrazone; (b) hexazinone; and (c) isoxaflutole.

6. A herbicidal composition comprising
i. at least one triazolone herbicide selected from amicarbazone, bencarbazone, carfentazone, flucarbazone, ipfencarbazone, propoxycarbazone, sulfentrazone and thiencarbazone;
ii. at least one photosystem II inhibitor herbicide selected from ametridione, amibuzin, ethiozin, hexazinone, isomethiozin, metamitron, metribuzin, trifludimoxazin, their salts and esters;
iii. at least one ALS inhibitor herbicide selected from an imidazolinone herbicide selected from imazamethabenz, imazamox, imazapic, imazapyr, imazaquin, imazethapyr and their salts and esters, or a bleacher herbicide selected from aclonifen, clomazone, diflufenican, isoxaflutole, mesotrione, picolinafen, sulcotrione, tembotrione, topramezone, bicyclopyrone, amitrole, beflubutamid, benzobicyclon, benzofenap, fluridone, flurochloridone, flurtamone, isoxachlortole, norflurazon, pyrasulfotole, pyrazolynate, pyrazoxyfen, and tefuryltrione; and,
iv. at least one agrochemically acceptable excipient.

7. The composition as claimed in claim 6, wherein the triazolone herbicide comprising sulfentrazone.

8. A method of controlling weeds at a locus, said method comprising applying to the locus, the combination of claim 1.

9. A kit-of-parts comprising:
a) a first container comprising sulfentrazone;
b) a second container comprising a photosystem II inhibitor herbicide and an ALS inhibitor herbicide selected from an imidazolinone herbicides or a bleacher herbicide; and
c) an instruction manual instructing a user to admix the contents of the first and second containers.
